(19) United States
(12) Patent Application Publication
(10) Pub. No.: US 2020/0134753 A1
(43) Pub. Date: Apr. 30, 2020

(54) System and Method for Assisting Real Estate Holding Companies to Maintain Optimal Valuation of Their Properties

(71) Applicant: Alexander Vickers, Addison, TX (US)

(72) Inventor: Alexander Vickers, Addison, TX (US)

(21) Appl. No.: 16/176,880

(22) Filed: Oct. 31, 2018

(51) Int. Cl. G06Q 50/16; G06Q 10/00; G06K 9/00; G06Q 40/08

(52) U.S. Cl. CPC G06Q 50/163; G06Q 40/08; G06K 9/00664; G06Q 10/20

(57) ABSTRACT

Method for assisting a real estate holding company to maintain an optimal valuation of a number of properties having a number of buildings includes the steps of selecting a property for inspection, launching an application, from an electronic computing device, for identifying one or more serviceable roofs among a number roofs of the buildings within the property, obtaining a series of time-lapse images of the roofs of the buildings within the property, analyzing the series of time-lapse images of the roofs using artificial intelligence-based instructions of the application to identify a variety of roof characteristics, identifying the buildings with one or more serviceable roofs requiring maintenance by analyzing a number of pixelated images of the roofs of the buildings and contacting an insurance service provider providing insurance coverage to the buildings with the serviceable roofs requiring maintenance to perform necessary maintenance activities.

### BACKGROUND OF THE INVENTION

### Field of the Invention

The disclosed principles relate generally to automated systems and methods for assisting real estate companies to maintain optimal valuation of their properties. More specifically, the disclosed principles relate to methods for assisting the real estate companies to identify the buildings with serviceable roofs and perform necessary maintenance to maintain the optimal valuation of the associated properties at minimal cost.

### Description Of The Related Art

Building roofs may get damaged due to various factors, such as, but not limited to, hail events, storms, other weather conditions, long service life, etc. The owners of multiple properties such as real estate holding companies need to know if their buildings associated with one or more properties at same or different geographical locations were actually damaged so that repairs may be made on time to maintain the optimal valuation of the properties and to claim the roofing insurance from the insurance provider. Further, the real estate holding companies, real estate buyers, sellers, and other entities engaged in the real estate business need to know the condition of their properties at any time, which would enable them to perform the necessary maintenance activities on the buildings to maintain the optimal valuation of the properties. The real estate holding companies, real estate buyers, sellers, and other entities engaged in the real estate business need to understand the potential value of each of their buildings and the quality of the roof is a major factor in the valuation of the buildings.

Severe weather activities such as hailstorm activities may damage the roofs of the buildings, which in turn decreases the valuation of the properties involving the buildings with the damaged roofs. For a large real estate holding company managing multiple properties with large numbers of buildings, typically owning 20 to 200 or more buildings, it is difficult for the relevant personnel to know which of their buildings have been impacted by a large hail stone storm. The manual inspection of all these building roofs is time consuming and expensive, which might further delay the maintenance activities and the decrease in valuation of the properties. Hence, there exists a need for a cost effective and faster way for the monitoring of the building roofs to identify the serviceable roofs with damages. Moreover the needed method would further enable the real estate holding companies to claim the insurance coverage on time for performing the maintenance activities on the roofs. In addition, the needed method would further assists the real estate holding companies to maintain the optimal valuation of the properties by proper identification of the damages and maintenance of the serviceable roofs of the buildings.

There are several prior arts that teach us the identification of condition of the roofs from images of the roofs captured using drones and other aerial image capturing methods. The roofing features identified from the images of the roofs is beneficial for the real estate holding companies, buyers and sellers of large buildings to understand the potential value of the buildings as well as for replacing and upgrading existing structures. Various software systems have been implemented to process aerial images to identify roofing characteristics of many roofing structures. However, such systems are often time-consuming and difficult to use, and require a great deal of manual input by a user. Further, such systems may not have the ability to improve results through continued usage over time. For real estate holding companies managing large number of properties, such systems often leads to large operating costs. The following prior arts are hereby incorporated by reference for their supportive teachings of the disclosed principles.

U.S. Pat. No. 8,731,234 titled “Automated Roof Identification Systems And Methods” issued to EagleView Technologies Inc. discloses an automatic roof identification systems and methods. The patent discloses a roof estimation system configured to automatically detect a roof in a target image of a building having a roof. Automatically detecting a roof in a target image includes training one or more artificial intelligence systems to identify likely roof sections of an image. The artificial intelligence systems are trained on historical image data or an operator-specified region of interest within the target image. Then, a likely outline of the roof in the target image can be determined based on the trained artificial intelligence systems. The likely roof outline is used to generate a roof estimate report.

U.S. Pat. No. 9,262,564 titled “Method Of Estimating Damage To A Roof” issued to State Farm Mutual Automobile Insurance Co. discloses a system and a method for estimating damage to a roof. The method includes the steps of generating, from a first point cloud representing a roof, a second point cloud representing a shingle. The system and method further includes comparing the second point cloud to a model point cloud, the model point cloud representing a model shingle. The method also includes identifying, based on the comparison, a first set of points, correlating each point within the first set of points to a representation of a point of damage. The system and method includes identifying a second set of points, the second set of points including at least one point from the first set, correlating the second set of points to a representation of a damaged region of the roof. Further, the method includes generating and storing to a memory a report based on the second set of points for subsequent retrieval and use in estimating damage to at least part of the roof. A damage assessment module operating on a computer system automatically evaluates a roof, estimating damage to the roof by analyzing a point cloud of a roof. The damage assessment module identifies individual shingles from the point cloud and detects potentially damaged areas on each of the shingles. The damage assessment module then maps the potentially damaged areas of each shingle back to the point cloud to determine which areas of the roof are damaged. Based on the estimation, the damage assessment module generates a report on the roof damage.

Another prior art, U.S. Pat. No. 9,613,538 titled “Unmanned Aerial Vehicle Rooftop Inspection System” issued to Unmanned Innovation Inc., discloses methods, systems, and apparatus, including computer programs encoded on computer storage media, for an unmanned aerial system inspection system. One of the methods is performed by a unmanned aerial vehicle (UAV) and includes receiving, by the UAV, flight information describing a job to perform an inspection of a rooftop. The UAV ascends to a particular altitude and an inspection of the rooftop is performed including obtaining sensor information describing the rooftop. Location information identifying a damaged area of the rooftop is also received. An inspection of the damaged area of the rooftop is performed including obtaining detailed sensor information describing the damaged area. The invention utilizes the UAV to schedule inspection jobs and to perform inspections of potentially damaged properties e.g., a home, an apartment, an office building, a retail establishment, etc. By intelligently scheduling jobs, a large area can be inspected using UAV(s), which reduces the overall time of inspection, and enables property to be maintained in safer conditions. Furthermore, by enabling an operator to intelligently define a safe flight plan of a UAV, and enable the UAV to follow the flight plan and intelligently react to contingencies, the risk of harm to the UAV or damage to surrounding people and property can be greatly reduced.

### SUMMARY

The disclosed principles relate to systems and methods for assisting one or more real estate holding companies to maintain an optimal valuation for a number of properties having one or more buildings managed by them. All the above systems and methods can be utilized to identify the damages to the roofs by random inspection of the roofs at any particular date or a selected time. However, such methods cannot be utilized to identify the serviceable roofs with damages, caused by severe weather activities such as hailstorm, among the roofs of the large number of buildings belonging to one or more properties spread over a large geographical area and managed by a large real estate holding company. Hence, there exists a need for an automated system and method for assisting the real estate holding companies, buyers and sellers of large buildings to understand the potential value of the buildings as well as for replacing and upgrading existing structures. The needed system and method would be able to identify the serviceable roofs with damages, among the roofs of the large number of buildings belonging to one or more properties of the real estate holding companies, caused by severe weather activities such as hailstorm over one or more geographical areas. Furthermore, the needed system and method would also assist the real estate holding companies to claim the existing roofing insurance from their insurance providers on time to perform maintenance on the damaged roofs.

Exemplary methods for assisting the real estate holding companies to maintain optimal valuation of the properties having one or more buildings includes the steps of selecting the properties managed by the real estate holding company for inspection and launching an application having a number of artificial intelligence-based instructions, from an electronic computing device, for identifying one or more serviceable roofs among the roofs of the buildings within the selected properties of the real estate holding company. Once the application is launched, the real estate holding company can obtain one or more images of the roofs of the buildings within the selected properties. The images of the roofs includes a series of time-lapse images of the roofs of the buildings obtained from the past and present satellite images of the properties captured over a selected period of time. As used herein, any reference to images or imaging includes any and all imaging technologies, and any images resulting therefrom, using any type of imaging technology either now existing or later developed. The real estate holding companies can now utilize the application for analyzing the images of the roofs using the artificial intelligence-based instructions of the application to identify information related to each of the roofs.

The information collected using the application includes a number of roof characteristics and a number of damage related information of each of the roofs during a selected period of time. The present application allows the real estate holding companies to inspect the roofs of the buildings prior to and after the severe weather activities capable of damaging the roofs. The information related to the roofs collected using the application is further utilized for identifying the buildings with the serviceable roofs requiring maintenance. The present application performs the automated conversion of the series of time-lapse images of the roofs to form the corresponding pixelated images and performs the analysis of the pixelated images to identify the sequential changes in the roofs. The artificial intelligence-based instructions of the present application thus identifies the serviceable roofs with damages by correlating the sequential changes identified from the pixelated images of the roofs and a number changes in the roof characteristics identified from the series of time-lapse images of the roofs with the weather activities capable of damaging the roofs occurred during the selected period of time. The roof characteristics are identified by comparing a number of features identified from the series of time-lapse images of the roofs to a number of predefined roof features associated with a number of roof types stored in a dynamically updated database associated with the application.

In some instances, the artificial intelligence-based instructions of the application performs analysis of the series of time-lapse images of the roofs, captured prior to and after the occurrence of the plurality of weather activities capable of damaging the roofs, to identify the damages on the roofs caused by the weather activities. The application further assists the real estate holding companies to contact the insurance service providers for claiming the insurance coverage to perform the necessary maintenance activities on the serviceable roofs of the buildings requiring maintenance. Thus, the present method enables the real estate holding companies to maintain the optimal valuation of the buildings associated with the properties by performing the necessary maintenance activities on the serviceable roofs of the buildings. In addition, the proper monitoring of the roofs of the buildings from a centralized location and the maintenance activities on the roofs enables the real estate holding companies to minimize the operating costs associated with the properties managed by them.

The disclosed principles also relate to a computer implemented system for assisting a plurality of real estate holding companies to maintain an optimal valuation for the properties with a number of buildings owned by them. The system includes an electronic computing device having a memory unit to store the instructions of the application for identifying the serviceable roofs among the roofs of the buildings within the properties managed by the real estate holding companies and a processor configured to execute the instructions of the application to perform a variety of tasks including obtaining the images of the roofs of the buildings within the properties, where the images of the roofs includes a series of time-lapse images of the roofs, obtained from the past and present satellite images of the properties, captured over a period of time selected by the real estate holding company. The processor further obtains the weather data of a geographical area covering the properties, during the selected period of time, from a weather data service provider and processes the images of the roof using the artificial intelligence-based instructions of the application to identify the information related to each of the roofs including the roof characteristics and the damage related information. The application running on the electronic computing device thus enables the real estate holding company to identify the serviceable roofs among the roofs of the buildings within the properties managed by them. This enables the real estate holding companies to contact the insurance service providers to claim the insurance coverage for performing the necessary maintenance activities on the roofs of the buildings belonging to the properties managed by the company. Thus, the present system assists the real estate companies to monitor the buildings within several properties spanned over various geographical locations from a centralized location and plan and perform the maintenance activities on time at minimal cost, which in turn helps to maintain the overall valuation of the properties.

Other features and other main features of the disclosed principles are discussed below. The disclosed principles are designed to fulfill the below and other additional features as detailed in the following claims section and detailed description section of the disclosed principles.

One feature of the disclosed principles provides a computer implemented method for assisting one or more real estate holding companies to maintain an optimal valuation for a number of properties having one or more buildings managed by them.

Another feature of the disclosed principles provides a computer implemented system having an electronic computing device running an application for assisting the real estate holding companies to identify the serviceable roofs among the roofs of the buildings belonging to their properties from a centralized location to perform the necessary maintenance to maintain an optimal valuation for the properties.

Another feature of the disclosed principles provides an electronic computing device running an application for assisting the real estate holding companies to identify the roof characteristics of a number of roofs of the buildings belonging to their properties from anywhere in real-time.

Another feature of the disclosed principles provides an application to assist the real estate holding companies to maintain the optimal valuation of the buildings associated with the properties managed by them at minimal operating costs.

Another feature of the disclosed principles provides an electronic computing device running an artificial intelligence-based application for identifying the serviceable roofs with damages among the roofs of the buildings belonging to their properties managed by the real estate companies.

Another feature of the disclosed principles provides a system having an electronic computing device running an application configured to identify the serviceable roofs with damages caused by the severe weather activities.

Another feature of the disclosed principles provides a system having an electronic computing device running the application to assist the real estate holding companies to request for an insurance claim from an insurance service provider for performing the maintenance activities on the serviceable roofs of the buildings associated with the properties managed by the real estate holding companies.

Another feature of the disclosed principles provides an application that enables the real estate holding companies to schedule and perform the planned maintenance activities on the serviceable roofs of the buildings associated with the properties at minimal cost.

Another feature of the disclosed principles provides an application that enables the real estate holding companies to estimate a valuation of one or more properties having one or more buildings based on the past and present information related to the roofs including the roof characteristics and the maintenance activities performed on the roofs of the buildings associated with the properties.

These, together with other features of the disclosed principles, along with the various features of novelty, which characterize the disclosed principles, are pointed out with particularity in the disclosure. For a better understanding of the disclosed principles, its operating advantages and the specific objects attained by its uses, reference should be had to the accompanying drawings and descriptive matter in which there are illustrated exemplary embodiments of the disclosed principles. In this respect, before explaining at least one embodiment of the disclosed principles in detail, it is to be understood that the disclosed principles are not limited in its application to the details of construction and to the arrangements of the components set forth in the following description or illustrated in the drawings. The disclosed principles are capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

To further clarify various aspects of some example embodiments of the disclosed principles, a more particular description of the disclosed principles will be rendered by reference to specific embodiments thereof that are illustrated in the appended drawing. It is appreciated that the drawing depicts only illustrated embodiments of the disclosed principles and are therefore not to be considered limiting of its scope. Elements in the figures have not necessarily been drawn to scale in order to enhance their clarity and improve understanding of these various elements and embodiments of the disclosed principles. Furthermore, elements that are known to be common and well understood to those in the industry are not depicted in order to provide a clear view of the various embodiments of the disclosed principles, thus the drawings are generalized in form in the interest of clarity and conciseness. The disclosed principles will be described and explained with additional specificity and detail through the use of the accompanying drawing in which:

FIG. 1 illustrates a schematic diagram of a system for assisting one or more real estate holding companies to maintain an optimal valuation for one or more properties having one or more buildings, according to an exemplary embodiment of the disclosed principles;

FIG. 2 is a block diagram showing a number of hardware and software components of the electronic computing device configured to run an application for identifying the serviceable roofs within the selected properties managed by the real estate holding companies, according to an embodiment of the disclosed principles;

FIG. 3 illustrates a flowchart showing a number of operating steps of the present application for assisting the real estate holding companies to maintain an optimal valuation for the properties having a number of buildings, according to an embodiment of the disclosed principles;

FIG. 4 is a chart showing the details of the hailstorm activities over a particular area covering the selected properties of the real estate holding company and the hailstone sizes fell during the particular hailstorm activity, according to an exemplary embodiment of the disclosed principles;

FIG. 5 is an exemplary image of a pair of roofs of the buildings, belonging to a property managed by the real estate holding company, obtained from the series of time-lapse images captured from the past and present satellite images of the selected geographical area(s) covering the selected properties managed by the real estate holding companies, according to an exemplary embodiment of the disclosed principles;

FIG. 6 is an exemplary flowchart showing the image processing steps for detecting the roof characteristics and damages on the roofs of the buildings associated with the properties managed by the real estate holding company, according to an embodiment of the disclosed principles;

FIG. 7 is an exemplary image of the roofs obtained from the series of time-lapse images captured from the past and present satellite images of the selected geographical area(s) covering the selected properties managed by the real estate holding company, according to an exemplary embodiment of the disclosed principles;

FIG. 8 to FIG. 10 shows exemplary images of a roof obtained from satellite images of the selected geographical area(s), covering the selected properties of the real estate holding companies, taken over a period of time, according to an exemplary embodiment of the disclosed principles; and

FIG. 11 is a flowchart showing the steps of the present method for assisting the real estate holding companies to maintain an optimal valuation for one or more properties owned by them, according to an exemplary embodiment of the disclosed principles.

### DETAILED DESCRIPTION

In the following discussion that addresses a number of embodiments and applications of the disclosed principles, reference is made to the accompanying drawings that form a part hereof, and in which is shown by way of illustration specific embodiments in which the disclosed principles may be practiced. It is to be understood that other embodiments may be utilized and changes may be made without departing from the scope of the disclosed principles. The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

Further, various inventive features are described below that can each be used independently of one another or in combination with other features. However, any single inventive feature may not address any of the problems discussed above or only address one of the problems discussed above. Further, one or more of the problems discussed above may not be fully addressed by any of the features described below. The following embodiments and the accompanying drawings, which are incorporated into and form part of this disclosure, illustrate one or more embodiments of the disclosed principles and together with the description, serve to explain the disclosed principles. To the accomplishment of the foregoing and related ends, certain illustrative aspects of the disclosed principles are described herein in connection with the following description and the annexed drawings. These aspects are indicative, however, of but a few of the various ways in which the disclosed principles can be employed and the subject disclosed principles are intended to include all such aspects and their equivalents. Other advantages and novel features of the disclosed principles will become apparent from the following detailed description of the disclosed principles when considered in conjunction with the drawings.

Further, the following section summarizes some aspects of the present disclosure and briefly introduces some exemplary embodiments. Simplifications or omissions in this section as well as in the abstract or the title of this description may be made to avoid obscuring the purpose of this section, the abstract and the title. Such simplifications or omissions are not intended to limit the scope of the present disclosure nor imply any limitations.

The disclosed principles relate to systems and methods for assisting one or more real estate holding companies to maintain an optimal valuation for one or more properties owned by them. In some other instances, the disclosed principles relate to a system and a method for assisting the real estate holding companies, real estate buyers, sellers, and other entities engaged in the real estate business to monitor and analyze the condition of one or more properties having one or more buildings. The properties owned by the real estate holding companies include a number of buildings having one or more types of roofs. The present systems and methods enables the real estate holding companies to monitor and identify the damages and other repairable parts of the roofs of the buildings from a centralized location without actual site visit by the relevant personnel associated with the real estate company to identify the extent of the damage or to identify the buildings with the serviceable roofs. The present systems and associated methods further enables the real estate companies to select the roofs of the buildings to be analyzed prior to and after certain weather activities capable of damaging the roofs. These weather activities capable of damaging the roofs may include harsh weather activities such as hailstorm, wind, rain and other weather activities.

Once the buildings with the serviceable roofs are identified by the real estate holding company, they can contact the respective insurance service providers to claim the insurance for performing the appropriate maintenance on the serviceable roofs. This way the real estate holding companies can maintain the optimal valuation of the building by performing necessary maintenance to the roof and other parts of the building. In some instances, the present systems and associated methods utilize artificial intelligence-based image processing to identify a variety of information related to the roofs of the buildings within the properties managed by the real estate companies. The real estate holding companies can utilize this information to monitor the roofs of the buildings within the properties managed by them, either continuously or at scheduled intervals or on demand. The proper identification of the damages on the roofs and other serviceable roofs, within certain period of time, enables the real estate companies to claim the insurance coverage for the roofs of the buildings for performing the relevant maintenance without fail. This further enables the real estate companies to reduce its overall operating and maintenance costs and at the same time maintaining the optimal valuation of the buildings within the properties. In addition, the present systems and methods allow the real estate holding companies to visualize the damages to the roofs of the buildings caused by the severe weather activities and the maintenance activities performed on the roofs after the severe weather activities that have caused damages to the roofs.

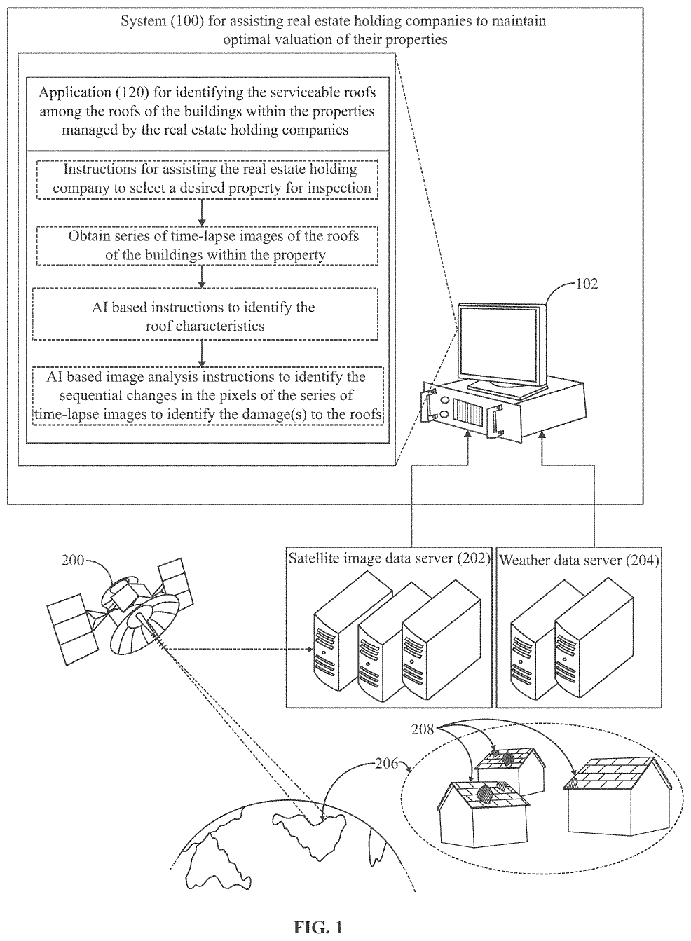

FIG. 1 illustrates a schematic diagram of a system 100 for assisting one or more real estate holding companies to maintain an optimal valuation for one or more properties having one or more buildings, according to an exemplary embodiment of the disclosed principles. The present system 100 for assisting the real estate holding companies to maintain optimal valuation for the properties managed by them includes an electronic computing device 102 configured to run an application 120 for identifying the buildings having serviceable roofs 208 among a number roofs of the buildings within the properties managed by the real estate holding companies, according to an exemplary embodiment of the disclosed principles. In an exemplary embodiment of the present system 100, the electronic computing device 102 is a computer having a memory unit to store a number of instructions of the application 120 for identifying the serviceable roofs 208 within the buildings located within the properties managed by the real estate holding companies and a processor to execute the instructions of the application 120 to perform a variety of image processing, data comparison and correlation steps to identify the serviceable roofs 208 with one or more damages on the roofs of the buildings belonging to the selected properties of the real estate holding companies. In some other embodiments, the electronic computing device 102 is a remote server computer having a memory unit to store the instructions of the present application 120 for identifying the serviceable roofs 208 of the buildings within the properties managed by the real estate holding companies. The electronic computing device 102 also includes one or more processors to process the instructions of the application 120 perform a variety of image processing, data comparison and correlation steps to identify the serviceable roofs 208 with one or more damages caused by severe weather activities within a selected geographical area covering the properties managed by the real estate holding companies. Further, in an exemplary embodiment of the disclosed principles, the instructions of the application 120 includes a number of artificial intelligence-based instructions, which when executed using the processor identifies the serviceable roofs 208 with one or more damages within the selected properties of the real estate holding company. In some instances, the application 120 collects the information related to the roofs, relevant for identifying the serviceable roofs 208, using a number of artificial intelligence-based instructions of the application 120. The artificial intelligence-based instructions of the present application 120 further improves the accuracy of automated identification of the serviceable roofs 208 with damages among the roofs of the buildings within the properties owned by the real estate holding companies by automatically updating the application 120 during each image processing, data comparison and correlation steps employed to identify the serviceable roofs 208 with the damages.

The instructions of the present application 120 for identifying the serviceable roofs 208 of the buildings within the properties managed by the real estate holding companies, when executed using the processor, performs a number of automated tasks such as, but not limited to, capturing one or more images of the roofs of the buildings within the selected properties managed by the real estate holding companies. As used herein, such images or image-capturing technology may encompass any and all imaging technologies, and any images resulting therefrom, using any type of imaging technology either now existing or later developed. Examples of such imaging technology may include infrared imaging, ultra-violet imaging, thermal imaging, or any one of a variety of multi spectral imaging technologies. In an exemplary embodiment of the disclosed principles, the images of the roofs of the buildings within the selected properties managed by the real estate holding companies is obtained from one or more satellite images captured using one or more satellites 200 covering one or more geographical area 206 covering the selected properties of the real estate holding companies. In some other instances, the present application 120 captures the images in form of a series of time-lapse images from a series of past and present satellite images, captured over a selected period of time, covering the selected properties managed by the real estate holding companies. In some embodiments, the present application 120 running on the electronic computing device 102 allows a user to set a desired time period and one or more geographical areas to receive the satellite images covering the geographical area(s) captured within the selected time period. The application 120 processes the received satellite images to generate the series of time-lapse images, which are further processed using the artificial intelligence-based instructions of the application 120 to identify the serviceable roofs 208, within the selected properties managed by the real estate holding companies, having one or more damages caused by severe weather activates or other causes occurred in the geographical area within the time period of capturing the satellite images. In some instances, the satellite images covering the geographical area(s), captured within the selected period of time, are obtained from an aerial image capturing application launched from the electronic computing device 102. In some other instances, the present application 120 for identifying the serviceable roofs 208 having one or more damages, within the selected properties managed by the real estate holding companies, communicates directly with the aerial image capturing application launched from the electronic computing device 102 to generate the series of time-lapse images covering the roofs of the buildings belonging to the selected properties managed by the real estate holding companies. In some other instances, the aerial image capturing application launched from the electronic computing device 102 communicates with a remote satellite image data server 202 to retrieve the satellite images of the geographical area(s), covering the selected properties managed by the real estate holding companies, captured within the selected period of time.

The instructions of the present application 120 for identifying the serviceable roofs 208 within the selected properties managed by the real estate holding companies, when executed using the processor of the electronic computing device 102, enables automated processing of the images of the roofs of the buildings within the selected properties managed by the real estate holding companies. The processing of these images, which is made available in form of the series of time-lapse images from the past and present satellite images of the properties captured within the selected period of time, identifies a variety of roof characteristics associated with each of the roofs in the images. In one or more embodiments of the disclosed principles, the roof characteristics identified by processing the images of the roofs includes a roof type, an age of the roof, at least one roof material, at least one roof dimension, at least one roof maintenance related information, at least one pre-existing roof damage related information, at least one material covering the roof, and other related roof information. In some instances, execution of the instructions of the application 120 using the processor of the electronic computing device 102 identifies the roof characteristics of each of the roofs in the images. The application 120 identifies the roof characteristics by comparing a variety of features of the roofs identified, using the artificial intelligence-based instructions of the application 120, from the series of time-lapse images of the roofs with a number of predefined roof features associated with different roof types stored in a dynamically updated database associated with the present application 120.

The instructions of the present application 120 for identifying the serviceable roofs 208 within the selected properties managed by the real estate holding companies, when executed using the processor of the electronic computing device 102 further enables the automated retrieval of the weather data of the geographical area covering the selected properties managed by the real estate holding companies over the selected period of time. In some instances, the application 120 retrieves the weather data associated with the geographical area during the selected period of time from a weather data service provider. In some other instances, the application 120 retrieves the weather data associated with the geographical area during the selected period of time from a remote weather data server 204 associated with the weather data service provider. The instructions of the application 120, when executed using the processor associated with the electronic computing device 102, enables the automated identification of one or more weather activities within the selected geographic area, during the selected period of time, capable of damaging one or more roofs of the buildings within the selected properties managed by the real estate holding companies. In some instances, the weather activates capable of damaging the roofs in the particular geographic area include hailstorm activities with varying hail stone sizes rated for damaging the different types of roofs. In some instances, the artificial intelligence-based instructions of the present application 120 predicts the roofs of the buildings within the selected properties managed by the real estate holding companies with high chances of getting damaged after the severe weather activities such as the hailstorm activities with hail stone sizes capable of damaging the roofs. The artificial intelligence-based instructions of the present application 120 further analyzes the series of time-lapse images of the roofs before and after the severe weather activities to identify the changes in the roof characteristics associated with the roofs of the buildings within the selected properties managed by the real estate holding companies.

Further, the instructions of the present application 120 for identifying the serviceable roofs 208 within the selected properties managed by the real estate holding companies, when executed using the processor of the electronic computing device 102, enables the conversion and analysis of the series of time-lapse images of the roofs through a number of image conversion steps including an image pixilation step to automatically identify one or more damages on the roofs of the buildings within the selected properties managed by the real estate holding companies. In some instances, the serviceable roofs 208, of the buildings within the selected properties managed by the real estate holding companies, with one or more damages are identified by analyzing the sequential changes in the pixels of the series of time-lapse images of the roofs of these buildings within the selected properties. These sequential changes in the pixelated images are then correlated with the roof characteristics such as the type of roof, material, age of the roof, etc., and the occurrence of the weather activities such as hailstorm activities during or prior to the duration of the series of time-lapse images to identify the sequential changes in the pixels of the series of time-lapse images pointing to the presence of any damages on the roofs. Thus, the present application 120 allows the real estate holding companies to identify the serviceable roofs 208 of the buildings within their properties to perform the necessary maintenance activities. The real estate holding companies can contact their roofing insurance service providers with the data provided by the application 120 to make an insurance claim for performing maintenance of the roof(s). In some embodiments, the application 120 for identifying the serviceable roofs 208 within the selected properties managed by the real estate holding companies provides a number of alerts and notifications to the relevant personnel regarding the serviceable roofs 208 within their properties based on the time period of the weather activities that have caused the damages to the roofs. This further enables the real estate holding companies to contact the insurance service providers within the stipulated timeframe of requesting for the roofing insurance claims. Thus, the real estate holding companies can utilize the present system 100 for minimizing the overall operating cost by minimizing the time and labor required for performing the inspection of the buildings, file for insurance claims for maintenance activities on the identified serviceable roofs 208 on time and to maintain the optimal valuation of the properties by performing the relevant maintenance activities to the buildings.

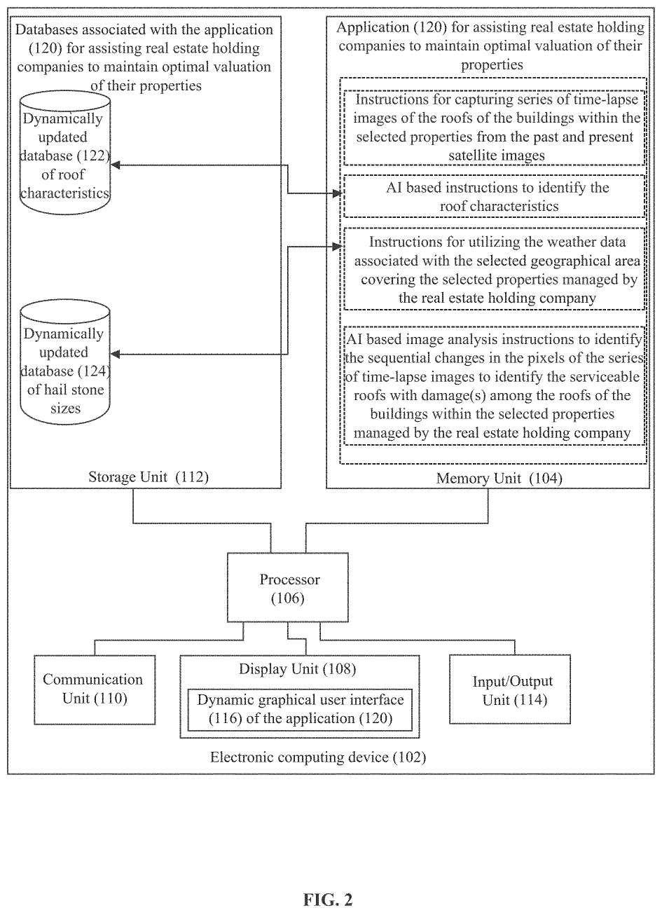

FIG. 2 illustrates a block diagram showing a number of hardware and software components of the electronic computing device 102 configured to run an application for identifying the serviceable roofs within the selected properties managed by the real estate holding companies, according to an embodiment of the disclosed principles. According to the embodiment, the electronic computing device 102 is a computer having a memory unit 104 to store the instructions of the application 120 for identifying the serviceable roofs within the selected properties managed by the real estate holding companies and one or more processors 106 to process the instructions of the application 120. The electronic computing device 102 further includes a display unit 108 to present the images of the roofs, which is available in form of the series of time-lapse images, through an interactive and dynamic graphical user interface 116 of the application 120 to visually identify the roof characteristics and the damages to the roofs. The electronic computing device 102 also includes a communication unit 110 to enable communication with the external network devices such as the other devices and servers through wired or wireless communication means to receive the images of the roofs of the buildings belonging to the selected properties managed by the real estate holding companies. Further, the weather data associated with the particular geographical area covering the selected properties of the real estate holding companies is collected from the weather data server 204 over the Internet using the communication unit 110. A storage unit 112 associated with the electronic computing device 102 stores a variety of information associated with the application 120 for identifying the serviceable roofs within the selected properties managed by the real estate holding companies. In some other embodiments of the disclosed principles, the storage unit 112 stores the instructions of the application 120 for identifying the serviceable roofs within the selected properties managed by the real estate holding companies and the instructions are made available to the memory unit 104 during execution using the processor 106. In a yet another embodiment, the storage unit 112 stores a number of information for further utilization by the application 120 during the execution of the instructions of the application 120 using the processor 106. Such information include, but not limited to, information related to the types and magnitude of weather activities capable of damaging the different roof types, types of hail stone sizes during a hailstorm capable of damaging the different roof types, general information related to the roof characteristics associated with different types of roofs, etc. The electronic computing device 102 also includes an input-output unit 114 to enable the device 102 to connect with peripheral devices such as, but not limited to, printers, keyboards, external display devices and other external electronic devices.

In some other embodiments, the information stored in the storage unit 112 of the electronic computing device 102 for further utilization by the application 120 is dynamically and automatically updated. In some other embodiments, the information stored in the storage unit 112, for further utilization by the application 120, is manually updated based on the visual verification or analysis of the images of the roofs obtained in form of the series of time-lapse images from the past and present satellite images of the selected geographical area, captured within the selected prior of time, covering the selected properties of the real estate company. The visual inspection of the series of time-lapse images reveal a number of information related to each of the roofs such as, but not limited to, the roof material, past maintenance information of the roof, type of roof, age of the roof, past and present condition of the roof etc. The users visually analyzing the series of time-lapse images of the roofs are allowed to dynamically update the roof related information stored in the storage unit 112. In some instances, the information related to the roof characteristics is stored in the storage unit 112 in form of a dynamically updated database 122. In addition, the weather data including the information related to the weather activities capable of damaging the different types of roofs are also stored in form of another dynamically updated database 124 within the storage unit 112. The present application 120 further allows the manual updating of both the databases 122 and 124 by visually analyzing the images of the roofs presented through the display unit 108 and by analyzing the relevant weather information received through other sources. In a yet another embodiment, the instructions of the application 120 stored in the storage unit 112 includes a number of artificial intelligence-based instructions configured to perform the automated processing and analysis of the images of the roofs, which is made available in form of the series of time-lapse images from the past and present satellite images of the geographical area captured within the selected period of time and covering the selected properties of the real estate company. The artificial intelligence-based instructions of the application 120 identifies the roof characteristics and the serviceable roofs, among the roofs of the buildings within the properties managed by the real estate company, with damages mainly caused by the severe weather activities. The artificial intelligence-based instructions of the application 120 when executed using the processor 106, enables automated updating of the dynamically updated database 122 for storing the identified roof characteristics, according to one or more embodiments of the disclosed principles. One or more features associated a variety of roofs types are stored in the database 122 and are automatically compared with the features of the roofs identified from the images of the roofs collected from the series of time-lapse images of the roofs of the buildings within the selected properties of the real estate company. The execution of the image processing instructions of the present application 120 using the processor 106 thus identifies the roof characteristics of each of the roofs of the buildings within the selected properties of the real estate company and updates the relevant information into the dynamically updated database 122 storing the roof characteristics of different types of roofs. Further, the artificial intelligence-based instructions of the application 120 enables the dynamic updating of the roof characteristics associated with each of the roofs into the dynamically updated database 122 and improves the speed and accuracy of automated identification of the roof characteristics associated with each of the roof types identified from the images. Similarly the artificial intelligence-based instructions of the present application 120, when executed using the processor 106, enables the automated identification of the weather activities, such as the magnitude of the hailstorm activities and sizes of the hail stones during the hailstorm activities, capable of damaging the different roof types. The artificial intelligence-based instructions of the application 120 analyzes the changes to the roofs prior to and after the severe weather activities and automatically updates the dynamically updated databases 124 of the weather activities stored in the storage unit 112 with the relevant information related to the severe weather activities capable of damaging the different roof types of the buildings within the selected properties of the real estate company.

In some other embodiments of the disclosed principles, the electronic computing device 102, is a portable electronic device such as, but not limited to, a smartphone, tablet, laptop and other portable devices capable of executing the instructions of the application 120 for identifying the serviceable roofs within the selected properties managed by the real estate holding companies. In some other embodiments, the electronic computing device 102 is any electronic device capable of launching the application, either installed into the device 102 or through a web interface. In such devices, the application is made available in form of a web application, or a software-as-a-service application, which can be accessed by the real estate holding companies from anywhere for identifying the serviceable roofs among the roof of the buildings within the properties managed by the real estate holding companies in real-time. In all such instances, the application 120 running on the electronic computing devices 102, which can be a computer at the real estate holding companies' location or a remote computer accessible to the authorized personnel from the real estate holding companies, enables automated capturing of the images of the roofs in form of the series of time-lapse images obtained from the past and present satellite images of the geographical area covering the properties managed by the real estate holding companies, automated identification of the roofing characteristics of each of the roofs based on the features of the roofs stored in the dynamically updated database 122, identification of probable serviceable roofs in the images by correlating the identified roof characteristics of each of the roofs with the weather activities during the period of capturing the satellite images and the identification of the serviceable roofs with severe damages by analyzing the sequential changes in the pixelated images of the roofs. The information related to the buildings with serviceable roofs can be submitted to the relevant insurance service providers to claim the insurance coverage for performing the maintenance activities on the roofs. This helps to maintain the optimal valuation of the properties owned or managed by the real estate companies.

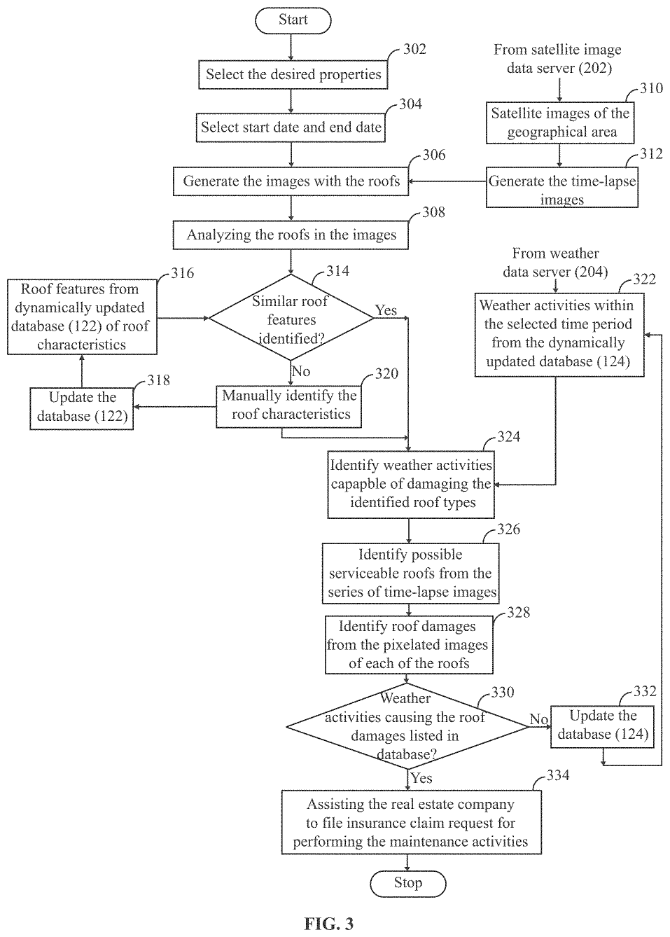

FIG. 3 illustrates a flowchart showing a number of operating steps of the present application 120 for assisting the real estate holding companies to maintain an optimal valuation for the properties having a number of buildings, according to an embodiment of the disclosed principles. The present application 120 performs a number of steps as discussed below to identify the serviceable roofs among the roofs of the buildings within the properties managed by the real estate holding company. The real estate holding companies can launch the application 120 from their electronic computing devices 102 such as a computer. The interactive dynamic graphical user interface 116 of the application 120 allows the users to set desired parameters for obtaining the details of the serviceable roofs among the roofs of the buildings within the properties managed by the real estate holding company. As shown in step 302, the interactive dynamic graphical user interface 116 of the application 120 allows the users to select the desired properties managed by the real estate holding company for capturing the images of the roofs of the buildings within the properties for further analysis and identification of the serviceable roofs with severe damages caused by weather and other activities. In some other instances, the interactive dynamic graphical user interface 116 of the application 120 can be utilized to select multiple properties of the real estate holdings spread over different geographical locations and simultaneously analyze the roofs in those properties to identify the serviceable roofs with damages among them. Further, the users or the real estate holding companies can select the period of time, such as a period covering before and after the severe weather activities, during which the changes in the roofs need to be analyzed. As in step 304, users can select a start date and an end date for obtaining the images of the roofs within the selected properties from the satellite images of the geographical area, covering the selected properties, captured within the selected period of time. The satellite images of the selected geographical area(s) covering the selected properties are obtained from the satellite image data server 202. In some instances, the satellite image data server 202 provides the satellite images of the selected geographical area(s) covering the selected properties through an application such as Google Earth, and other regional satellite aerial image capturing applications launched from the electronic computing device 102. In some instances, the present application 120 for assisting the real estate holding companies to maintain an optimal valuation for the properties having a number of buildings communicates directly with the satellite image capturing applications for capturing the images of the geographical area covering the selected properties owned by the real estate companies within the selected period of time, as in step 310. Now the series of time-lapse images of the selected properties owned by the real estate companies is obtained from the satellite images in the step 312. In some instance, the present application 120 for assisting the real estate holding companies to maintain an optimal valuation for the properties obtain the images of the roofs of the buildings in the selected properties by expanding and cropping the time-lapse images obtained from the satellite images of the geographical area, captured within the selected time period, as in block 306.

The instructions of the present application 120 for assisting the real estate holding companies to maintain an optimal valuation for the properties, when executed using the processor 106 of the electronic computing device 102, such as the computer provided with the real estate companies, enables the automated analysis of each of the roofs present in the images obtained in form of the time-lapse images of the roofs of the buildings in the selected properties, which is shown in step 308. In an exemplary embodiment, the storage unit 112 of the electronic computing device 102 stores the dynamically updated database 122 of roof characteristics or roof features associated with a variety of types of roofs. The application 120 communicates with the dynamically updated database 122 of the roof characteristics to identify the types and characteristics of each of the roofs in the images as in step 316. The application 120 includes image processing instructions that identify the features, such as, but not limited to, color of the roofs, from each of the images to identify the type and the characteristics of each of the roofs in the images. As in step 314, the present application 120 identifies the similar roof features by analyzing the detected features from the images to the previously stored features from the database 122. In case the roof features are not identified from the database, the application 120 instructs the user associated with the real estate holding company to manually identify the roof characteristics, as in step 320. These manually identified roof features, which are not present in the database 122 are dynamically updated by the application 120 from the user inputs related to the roof characteristics and the type of roof, which is shown in the flow diagram involving step 318.

In one or more embodiments of the disclosed principles, the image processing technique(s) performed by the processor 106, by executing the image processing instructions or the artificial intelligence-based instructions of the application, enables any suitable image detection, feature detection/extraction, pattern detection, edge detection, corner detection, blob detection, ridge detection, color detection, and/or any other image processing technique(s) to determine the roof characteristics of each of the roofs present in the series of time-lapse images obtained from the past and present satellite images of the selected geographical area(s) covering the selected properties of the real estate holding companies. In some instances, the image processing instructions of the present application, when executed using the processor 106, performs a series of image processing steps, which are commonly employed to identify features from the digital image, such as, but not limited to, SIFT (Scale-Invariant Feature Transform) technique, a SURF (Speeded Up Robust Features) technique, and/or a Hough transform technique, etc., to detect the roof characteristics of each of the roofs present in the images available in form of the series of time-lapse images obtained from the past and present satellite images of the selected geographical area(s) covering the selected properties of the real estate holding companies.

In some other embodiments of the disclosed principles, the image processing instructions of the present application 120, when executed using the processor 106 of the electronic computing device 102, enables identification of one or more features of the roofs and compares the identified features with the predefined or previously stored features or the roof characteristics in the dynamically updated database 122 in real-time. In some other embodiments, the image processing instructions of the application 120 include a number of artificial intelligence-based instructions configured to identify the roof characteristics, such as but not limited to, roofing material, roofing type, age of the roof, etc., by generating a matching score when comparing with the previously stored features or the roof characteristics in the dynamically updated database 122 in real-time. In a yet another embodiment, the present application 120 for identifying the serviceable roofs of the buildings in the selected properties managed by the real estate companies may incorporate a image processing and roof characteristics identification module that performs the image processing to determine which of the products or features of the roofs in the database 122 are associated with roof characteristics that “match,” or are sufficiently “similar” to, the roof characteristics of the roof determined by the present application 120. The processing steps for determining whether a particular roof characteristics in the database 122 “matches” the roof characteristic of the roofing materials present in the images may vary according to different embodiments. In some other instances, the dynamically updated database 122 storing the roofing characteristics of a variety of types of roofs may assist the application 120 to identify the roof features or the roofing characteristics of each of the roofs in the images using one or more roofing part manufacturer characteristics, such as, but not limited to, tab or tile length, recommended installation pattern, recommended exposure width, etc., associated with the roofing product. In some other instances, the dynamically updated database 122 associated with the present application may include a single database or additionally include one or more third party databases such as the respective roofing material product manufacturers or suppliers.

Once the roof features of each of the roofs are identified, the present application 120 identifies the weather activities, occurred within the selected period of time, capable of damaging the identified roofs. In a certain embodiment of the disclosed principles, the weather data of the selected geographical area(s) covering the selected properties of the real estate holding company is collected from a weather data service provider such as, but not limited to, national weather data service provider. In such an instance, the present application 120 communicates with the national weather data service provider server 204 to collect the weather data within the selected period of time. In an exemplary embodiment, the present application 120 communicates with the national oceanic and atmospheric administration servers 204 for obtaining the weather data and the received weather data map of the area within the selected period of time is overlaid on the past and present satellite images, such as, but not limited to Google Earth images, of the selected geographical area(s) covering the selected properties of the real estate holding company, captured within the same period of time. This allows the present application 120 to analyze both the images of the weather activities and the series of the time-lapse images of the roofs to identify the serviceable roofs or roofs of the buildings with damages or roofs with high chances of getting damaged from the weather activities within the selected properties of the real estate holding company. This also enables the real estate holding companies to manually identify the weather activities capable of damaging the roofs of the buildings within their properties. This would further assist the real estate holding companies to properly manage the roofs of the buildings to ensure the optimal valuation of the properties.

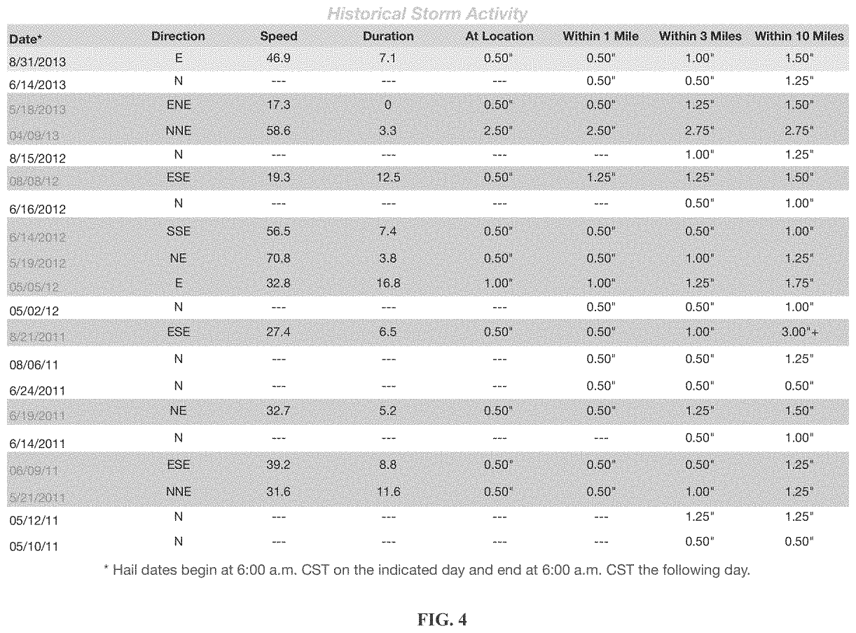

In some other instances, the weather data of any selected geographical area covering the selected properties of the real estate holding company is collected from multiple weather data service provider servers 204 such as, but not limited to, www.interactivehailmaps.com, national oceanic and atmospheric administration and other weather data service providers. These weather data maps may include the detailed map of the hailstorm activities over the selected geographical area(s) covering the selected properties of the real estate holding company, which are analyzed by the present application in real-time to identify the possible serviceable roofs of the buildings in the selected properties of the real estate holding company. FIG. 4 is a chart showing the details of the hailstorm activities over a particular area covering the selected properties of the real estate holding company and the hail stone sizes fell during the particular hailstorm activity, according to an exemplary embodiment of the disclosed principles. Certain weather data service providers such as the www.interactivehailmaps.com site allows the real estate holding companies to select a particular geographical area covering the selected properties of the real estate holding company to retrieve the past and present hailstorm activities details, within the selected time period and the results are presented to the application 120 for further processing to identify the roofs of the buildings within the selected properties of the real estate holding companies with high probability of getting damaged from the hailstorm activities. The hailstorm chart thus obtained from the weather data service provider servers 204 provide the dates of occurrences of the hailstorm activities at a certain building address or a selected geographical area covering the properties of the real estate holding companies. The weather data service provider servers 204 also provide the sizes of the hailstones, which include small hail stones that does minimal damage to the roofs, and larger hailstones of sizes 3.8 cm, which is the minimum threshold for damage to commercial roofing materials and above capable of damaging the roof materials and other A/C coils of rooftop HVAC accessories, during each of the hailstorm activities. The dates of each of the hailstorm activities can be directly obtained from the chart shown in FIG. 4, which can further be utilized to analyze the changes to the roofs of the buildings in the selected properties of the real estate holding companies prior to after the particular hailstorm activity to identify the changes to the roofs, which in turn helps to identify the serviceable and possible serviceable roofs in the selected properties of the real estate holding companies.

Referring back to FIG. 3, the application 120 for assisting the real estate holding companies to maintain an optimal valuation for the properties retrieves the weather data for the selected period of time as discussed in the above paragraphs from the dynamically updated database 124, as in step 322. The weather data of the selected geographical areas covering the selected properties is correlated with the roof types or the roof characteristics of each of the roofs identified from the images to identify the possible serviceable roofs with one or more damages caused by the severe weather activities. In step 324, the weather activities occurred within the selected period of time, which is collected from the dynamically updated database 124 for the weather activities as in FIG. 4, and capable of damaging the different types of roofs identified from the images received by the application 120 are identified. This, as in step 326, leads to the shortlisting of the roofs with high chances of serviceability with damages, which might be caused by the severe weather activities occurred within the selected period of time. In some instances, the artificial intelligence-based image-processing instructions of the application processes the series of time-lapse images of the roofs to identify the changes in the series of time-lapse images to identify the damages on the roofs. In some instances, the damages on the roofs is identified by comparing a number of sequential changes in one or more pixels of the series of pixelated time-lapse images, one or more changes in the roof characteristics identified from the series of time-lapse images and correlating the information thus collected with the weather activities capable of damaging the respective roof type during the time period of capture of the past and present satellite images forming the series of time-lapse images. The weather activities capable of damaging the different roofs types may vary, however the threshold values of each weather activity for damaging each type of roof is identified from the dynamically updated database 124 of the weather activities stored in the stored in the storage unit 112 of the present electronic computing device 102 running the application 120. In some instances, the weather activities capable of damaging the different roof types include heavy rain, wind, storm, lightning, other weather related activities and hailstorm activities with hail stone sizes of 4.8 cm or more capable of damaging the different roof types. In some instance, the dynamically updated database 124 of the weather activities stored in the stored in the storage unit 112 of the present electronic computing device 102 may include the threshold sizes of the hail stones capable of damaging each types of roofs. Thus, by comparing the weather activities in the particular geographical area with in the selected time period, roof characteristics of each of the roofs of the buildings in the selected properties managed by the real estate holding companies and the sequential changes in one or more pixels of the series of pixelated time-lapse images of each of the roofs, the application 120 can identify the serviceable roofs with damages among the roofs of the buildings in the selected properties of the real estate companies, as in step 328.

Once the serviceable roofs with the damages are identified from the pixelated images of the roofs, which are obtained from the series of time-lapse images of the roofs captured from the past and present satellite images of the selected properties of the real estate companies, the present application 120 assists the real estate holding company managing the properties to file a request for claiming the insurance coverage for performing the maintenance activities on the serviceable roofs with damages, as in step 334. In some other instances, the artificial intelligence-based instructions of the application 120 when executed using the processor 106 predicts the serviceable roofs in the properties of the real estate holding companies and a variety of roofing maintenance related information of each of the serviceable roofs with damages. These roofing maintenance related information includes at least one type of roof maintenance required, an approximate cost of maintenance, materials required for roof maintenance, a time frame for availing the roofing insurance claims and other relevant maintenance information. This allows the real estate holding companies to plan and perform the necessary maintenance activities on the serviceable roofs with damages to properly maintain the roofs of the buildings. In some embodiments, the same weather activities affect each type of roofs differently and some may cause damages and some only contributes to the change in appearance of the roofs. In some other instance, some weather activities, rated for damaging the particular roofing type only makes small defects that are not necessarily to be treated immediately, and the artificial intelligence-based instructions of the present application automatically updates the database 124 of weather activities and threshold values of each of the weather activities capable of damaging the each roof type as in steps 330 through 332. However, in some instances, the effect of the weather activities and the threshold values of each of the weather activities obtained from the database 124 may vary depending upon a previous maintenance status, age and other previous condition of the roofs prior to the selected time period for analysis. The artificial intelligence-based instructions of the present application 120 takes into account of all these factors and automatically learns and updates the database 124 for predicting the serviceable roofs and for identifying the serviceable roofs having one or more damages with higher accuracy over time.

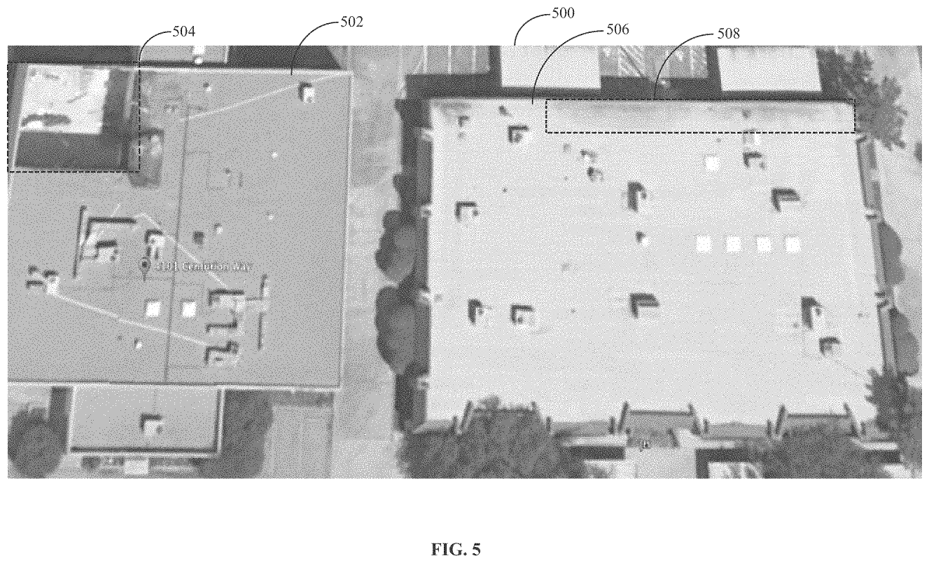

The identification of the serviceable roofs among the roofs of the buildings within the properties managed by the real estate holding company utilizing the present application 120 is explained with the help of exemplary images of a pair of roofs as below. FIG. 5 is an exemplary image 500 of the roofs of the buildings, belonging to the properties managed by the real estate holding company, obtained from the series of time-lapse images captured from the past and present satellite images of the selected geographical area(s) covering the selected properties managed by the real estate holding companies, according to an exemplary embodiment of the disclosed principles. The application 120 identifies the type of roof 502 on the left side of the image 500, which is captured on a date Mar. 1, 2011, as a gravel ballasted built up roof, from a brown color of the roof 502 and the lack of dark spots. The dark spots in the images of the roofs generally represent the presence of dirt and algae that has been left over from ponding water. The lack of dark spots on the roof 502 on the left side of the image 500 denotes the absence of dirt and algae that has been left over from ponding water commonly seen on other roof types. Further, the image processing instructions of the present application 120 is capable of differentiating the types of the roof 502 from tan colored torch down roof with the lack of seams, made by rolls of roof material forming regular, repeating seams at the joints. In some other instances, the present application 120 detects the type of roof by identifying the seams of the material covering the roof and categorizing the material based on the width of the seams. Further, the image processing instructions of the present application 120 detects a missing section or damage 504 at a top left corner, which is of different color compared to the other roof parts. The instructions of the present application identifies the missing section or damage 504 at a top left corner of the roof 502 by analyzing the image 500 captured on the above said date Mar. 1, 2011 on a series of time-lapse images captured prior to and after the above mentioned date. The present application then looks into the weather activities happened prior to the above said date and analyzes the series of time-lapse images captured prior to and after the above mentioned date to identify the type of weather activity, such as, but not limited to a storm event or similar, responsible for the fault or the damage.

Further, the present application analyzes the roof 506 on the right side of the image 500 to identify the roof characteristics, such as the presence of dark stains along the rear edge 508 of the roof 506, which may be caused by the collection of algae and dirt near the drains. The continuous monitoring of the dark stains along the rear edge 508 of the roof 506 through the series of time-lapse images of the roof 506 helps to identify the maintenance status, replacement or roofing material and the other relevant information of the roof 506. The present application 120 allows the automated analysis and manual inspection of the roofs present in the series of time-lapse images obtained from the past and present satellite images of the geographical area(s) covering the selected roofs of the buildings associated with the properties managed by the real estate holding companies. This in turn improves the accuracy of the present application 120 in detecting the roof characteristics and damages on the roofs of the buildings associated with the properties managed by the real estate holding companies. The automated inspection of the series of time-lapse images of the roofs is performed in a number of methods as discussed earlier. However, an exemplary embodiment of the present application 120 employs one or more image pixilation steps to identify the sequential changes in each pixel of the series of time-lapse images of the roofs for accurate identification of the roof characteristics and damages on the roofs. One such exemplary method for detecting the roof characteristics and damages on the roofs is discussed below.

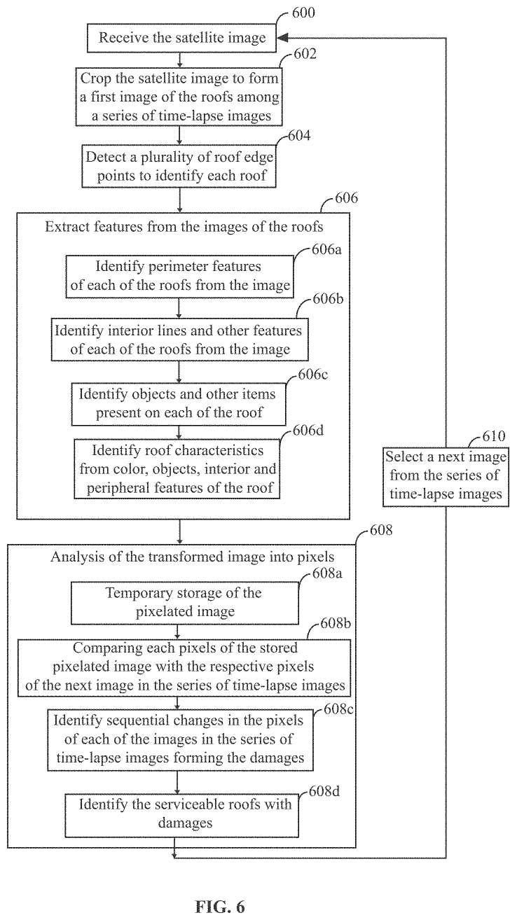

FIG. 6 is an exemplary flowchart showing the image processing steps for detecting the roof characteristics and damages on the roofs of the buildings associated with the properties managed by the real estate holding companies, according to one or more embodiments of the disclosed principles. From the first step 600, the application 120 receives the satellite image of the selected geographical area covering the selected properties managed by the real estate holding companies, which is captured at a specific date, such as the one captured on Mar. 1, 2011, as discussed above. Now as in step 602, the satellite image is cropped to select the desired image covering the desired number of roofs covering the selected buildings associated with the properties managed by the real estate holding companies. This image forms the first image of the series of time-lapse images captured from the past and the present satellite images. Now as in step 604, the image processing instructions of the application 120 perform a variety of image processing steps to identify the edges of the roofs using an edge detection algorithm or method commonly employed in image processing application. In step 606, the image processing instructions of the present application 120 further extracts the roof features from the image in a number of steps from 606a to 606d. In some instances, the step for identifying the roof features may include the steps of identifying the perimeter features of the roof from the image as in step 606a, then identifying the interior lines and other interior features of the roof within the perimeter as in step 606b, then identification of the objects such as HVAC coils present in the roof as in step 606c and using the above information along with the color and other identified features of the roof to define the roof characteristics of each of the roof as in step 606d. In this stage, the present application makes use of the stored roof features of a variety of roof types from the database 122 for proper identification of the roof type and other features of the roof. Now, in order to detect the damages on the roof, which may be caused by the severe weather activities occurred on that geographical area, the images are transformed into pixels in step 608. In this stage, the application 120 communicates with the weather data server 204 and the stored weather activity related information capable of damaging differ types of roofs. In step 608a, the pixelated image is stored in a temporary storage for further comparison in step 608b, in which each pixel of the subsequent images in the series of time-lapse images are compared to identify the sequential changes in the pixels of each image as in step 608c. Now, as in 608d, the application 120 identifies the damages on the roof by comparing the sequential changes, which are happened prior to and after the severe weather activities, in the pixels of each image in the series of time-lapse images obtained from the satellite images. For example, if the same black spots exist with the addition of other black spots in the nearby pixels in the sequential images, which indicates that the same roof exists and has not been replaced and the black spots are growing or being added over time, with the increase in the age of the roof. The process is repeated until all the images in the series of time-lapse images are processed to identify the serviceable roofs with damages as in step 610.

The image processing instructions of the present application 120 may employ a variety of image processing techniques, some of which are disclosed below with the help of similar image processing techniques employed by several image processing prior art patent teachings. One such image processing technique employed in U.S. Pat. No. 7,711,157 titled “Artificial Intelligence Systems For Identifying Objects”. The process for object identification, according to the prior art, comprising extracting object shape features and object color features from digital images of an initial object and storing the extracted object shape features and object color features in a database where said extracted object shape features and object color features are associated with a unique identifier associated with said object and repeating the first step for a plurality of different objects. Then, extracting object shape features and object color features from a digital image of an object whose identity is being sought and correlating the extracted object shape features and object color features of the object whose identity is being sought with the extracted object shape features and object color features previously stored in the database. If a first correlation of the extracted object shape features is better than a first threshold value for a given object associated with an identifier in the database and if a second correlation of the extracted object color features is better than a second threshold value for the given object, then making a determination that the object whose identity is being sought is said given object. In an embodiment, one or more steps of the above object identification utilizing object color, texture and shape features can be employed in the present application 120 for identifying the roof characteristics of the roofs and to identify one or more objects present on the roofs.

Another prior art utilizing artificial intelligence-based image-processing techniques, which can be incorporated into the image processing steps of the disclosed principles, is the U.S. Pat. No. 9,679,227 titled “System And Method For Detecting Features In Aerial Images Using Disparity Mapping And Segmentation Techniques”. The disclosed prior art system for aerial image detection and classification includes an aerial image database storing one or more aerial images electronically received from one or more image providers, and an object detection pre-processing engine in electronic communication with the aerial image database, the object detection pre-processing engine detecting and classifying objects using a disparity mapping generation sub-process to automatically process the one or more aerial images to generate a disparity map providing elevation information, a segmentation sub-process to automatically apply a pre-defined elevation threshold to the disparity map, the pre-defined elevation threshold adjustable by a user, and a classification sub-process to automatically detect and classify objects in the one or more stereoscopic pairs of aerial images by applying one or more automated detectors based on classification parameters and the pre-defined elevation threshold. One or more image analysis steps of the above prior art can be utilized by the present artificial intelligence-based image processing instructions of the present application 120 to identify the roof features from the images captured from the past and present satellite images.

Another prior art disclosing the image processing steps to identify the features from the images is disclosed in U.S. Pat. No. 5,625,710. The prior art recognizes the features such as the character from an image using pixelated form of the images to compare with a reference image to identify the changes in the pixels of the image from the reference image to identify the characters. A similar processing step can be used by the artificial intelligence-based image processing instructions of the present application 120 to identify the damages to the roofs by comparing with a previous image of the roof, before the damages, from the series of time-lapse images.

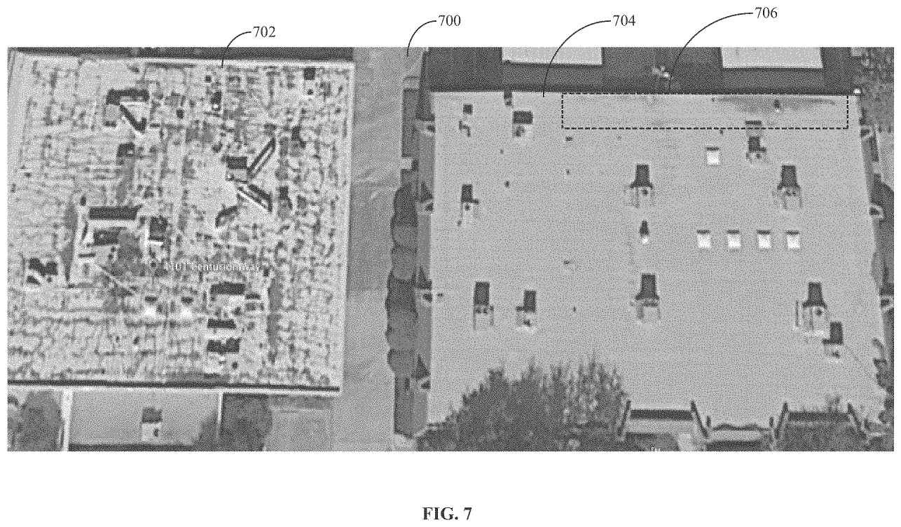

Once the serviceable roofs among the roofs of the buildings within the selected properties managed by the real estate holding companies are identified, the real estate holding company can either contact the relevant insurance service providers providing insurance coverage to the buildings with the serviceable roofs for obtaining the insurance coverage to perform the necessary maintenance activities on the roofs. The following analysis of the images of the same roofs captured on a later date, after performing the proper maintenance activities on the roofs to cover the damages on it, reveals the type of maintenance activity performed on the roofs and a present status of the roofs, according to one or more exemplary embodiment of the disclosed principles. The above past maintenance related information is further useful to the real estate holding company during its future claims for insurance coverage to perform the maintenance activities on a future date. FIG. 7 is an exemplary image 700 of the roofs obtained from the series of time-lapse images captured from the past and present satellite images of the selected geographical area(s) covering the selected properties managed by the real estate holding companies, according to an exemplary embodiment of the disclosed principles. The roofs 702 and 704 in the image 700 are taken from the satellite image, of the geographical area covering the selected properties, captured on Jan. 7, 2017, after 6 years from the data of capture of the image 500 in FIG. 5. From the visual analysis of the image 700 and image 500 in FIG. 5, it is clear that the top left hand square marked as 504 in FIG. 5 is repaired. Furthermore, the color and texture of the roof 702 in image 700 is changed from the roof 502 present in the image 500. This indicates the maintenance activity on the roof 502 within the six years period and the material of the roof 702 is changed from ‘gravel ballasted built up roof’ to ‘spray foam/elastomeric coated roof’. The material change on the roof 702 is identified by analyzing the pixilated image showing dark and light colors compared to the pixels of the roof 502 in the image 500. Moreover the damaged part 504 present in the roof 502 in the image 500 is also missing, pointing to a maintenance activity. The roof 704 on the right shows little growth to the dark stains along the rear edge 706, which when compared with the dark stains along the rear edge 508 of the roof 506 in FIG. 5, shows that the roof must have been repaired recently with the same material. The above information is stored in the roof characterizes of the particular roof in the selected properties of the real estate holding companies and is later utilized by the present application 120 for identifying the serviceable roofs with damages caused by the severe weather activities. In some instances, the present application identifies the severe weather conditions around a particular date and analyzes the images of the roofs captured prior to and after the severe weather activities to identify the damages on the roofs caused by the weather activities such as hailstorm activity with hail stone sizes higher that a preset threshold value for the particular roof type. Table 1 and Table 2 show an exemplary threshold hailstone sizes chart for different roof types, which are utilized during the analysis of the images prior to and after the hailstorm events to easily identify the roofs with high probability of getting damaged, along with the other roof characteristics of the roofs identified from the images of the roofs.

TABLE 1
Hail threshold for low slope roof coverings

| Roof Type | Threshold Value (inches) |
|---|---|
| Built-up roofing-smooth | 1½ to 2 |
| Built-up roofing-aggregate surfaced | 2 1/2 |
| Polymer modified bitumen membrane | 1½ to 2 |
| Thermoplastic single ply membrane | 1 to 2 |
| EPDM | 2 |
| EPDM-ballasted | 2 1/2 |
| Spray polyurethane foam | ¾ |
| Steel panels | 2 1/2 |

The below table, Table 2 shows experimental results of the threshold hail sizes for causing damages to the different roof types.

TABLE 2
Hail stone impact test results for various roof type

| | | Hail- | Hail- | Hail- | Hail- | Hail- |
|---|---|---|---|---|---|---|
| Type of | | stone | stone | stone | stone | stone |
| roofing | Age | 25 mm | 32 mm | 38 mm | 44 mm | 50 mm |
| 3-tab fiber | 11 | 0 | 60 | 90 | 100 | 100 |
| glass | | | | | | |
| shingles | | | | | | |
| 3-tab organic | 11 | 50 | 90 | 100 | 100 | 100 |
| shingles | | | | | | |
| 30-year | 11 | 0 | 0 | 60 | 90 | 100 |
| laminated | | | | | | |
| shingles | | | | | | |
| Cedar | 11 | 0 | 30 | 80 | 100 | 100 |
| Shingles | | | | | | |
| Heavy Cedar | 0 | 0 | 0 | 50 | 90 | 100 |
| shakes | | | | | | |
| Fiber cement | 0 | 0 | 20 | 80 | 100 | 100 |
| tiles | | | | | | |
| Flat concrete | 0 | 0 | 20 | 50 | 50 | 100 |
| tiles | | | | | | |
| S-shaped | 0 | 0 | 0 | 0 | 0 | 80 |
| concrete | | | | | | |
| tiles | | | | | | |
| Built-up | 8 | 0 | 0 | 0 | 0 | 30 |
| gravel | | | | | | |
| roofing | | | | | | |
| No. of | | 1/9 | 5/9 | 7/9 | 7/9 | 9/9 |
| products | | | | | | |
| damaged | | | | | | |

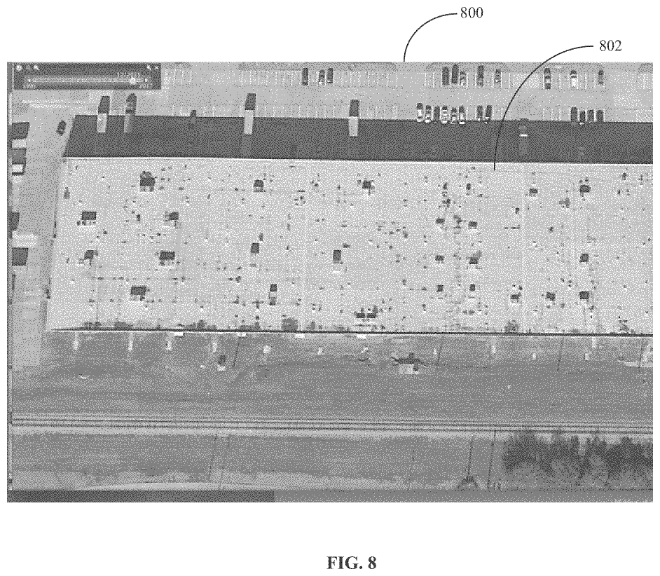

Another exemplary embodiment related to the maintenance activities performed on the roof of a building belonging to a selected property managed by the real estate holding company is visually presented through the images from FIG. 8 to FIG. 10. FIG. 8 to FIG. 10 shows exemplary images 800 of a roof obtained from satellite images of the selected geographical area(s), covering the selected properties of the real estate holding companies, taken over a period of time from a first date Dec. 1, 2015 to a current date Jan. 4, 2018, according to an exemplary embodiment of the disclosed principles. In FIG. 8, the roof 802 in the image 800 is made up of material such as spray foam with an elastomeric coating with no signs of any damages present on the roof 802. The present application 120 captures and processes the series of time-lapse images of the roof between the period from Dec. 1, 2015 to a current date Jan. 4, 2018 to identify the changes in the roof characteristics, including roof type, material, maintenance performed on the roof during this period, damages caused by the weather activities during this period etc.

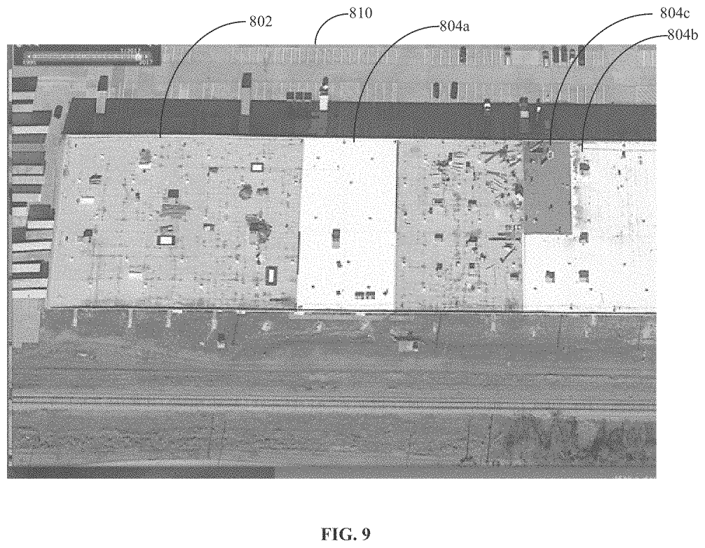

FIG. 9 is an image 810 of the roof 802 obtained from satellite images of the selected geographical area(s), covering the selected properties of the real estate holding companies, taken on the date Jan. 9, 2017 within the selected period of time, i.e. within the period from Dec. 1, 2015 to the current date Jan. 4, 2018, according to an exemplary embodiment of the disclosed principles. From the analysis of FIG. 9, either visually or using the artificial intelligence-based image processing instructions of the application 120, it is clear that certain sections such as 804a to 804c of the roof 802 is modified using different materials. The present application 120 can further identify the causes of the damages that led to the maintenance at sections 804a, 804b and 804c of the roof 802 by correlating the images captured within the above time period with the weather activities that happened in the same time period covering the particular geographical area. The present application can analyze the series of time-lapse images of the roof 802 captured within the above said time period and process the images to create the corresponding pixelated images. The artificial intelligence-based image processing instructions of the application 120 analyzes and compares the sequential changes in each of the pixels in the series of time-lapse images of the roof 802 and correlates with the weather information collected over the period of time to identify the damages caused on the roof 802 during this period. In a certain instance, a hailstorm activity with hail stone sizes larger than the threshold value capable of damaging the particular roof type may have fallen on the roof 802 within the above said time period, which led to the damages of the roof 802 at sections 804a, 804b and 804c of the roof 802. Furthermore, the artificial intelligence-based image processing instructions of the application 120 identifies the roofing material covering the sections 804a, 804b and 804c of the roof 802, which are different from the original roofing material of the roof 802. In some instances, the sections 804a and 804b are covered using spray polyurethane foam or thermoplastic polyolefin (TPO) sheet products and the section 804b is covered using material such as fiber cement tiles. In addition, the artificial intelligence-based image processing instructions of the application 120 identifies that the maintenance on the section 804b is performed on an earlier date than the section 804a. This is identified by the presence of dark spots on the roof section 804b, which is caused by the deposition of dirt and algae over time. The roof material at the section 804a is almost white, which lets the artificial intelligence-based image processing instructions of the application 120 to interpret a more recent maintenance activity on that part of the roof 802.

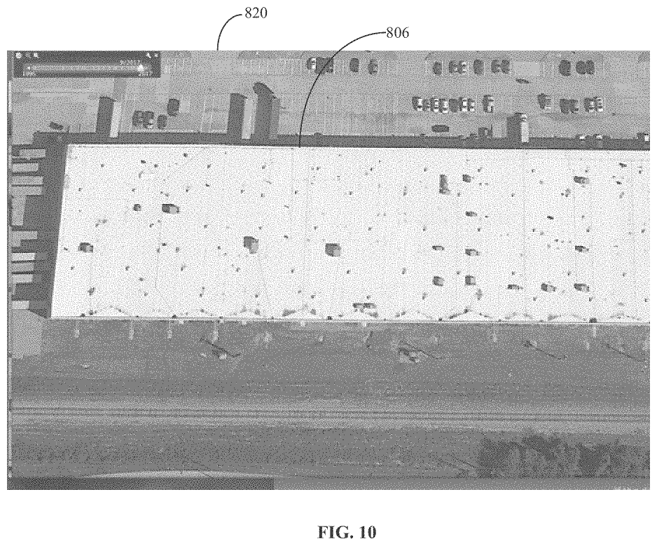

FIG. 10 is an image 820 of the roof 806 obtained from satellite images of the selected geographical area(s), covering the selected properties of the real estate holding companies, taken on the current date Jan. 4, 2018, according to an exemplary embodiment of the disclosed principles. The analysis of the image 820 of the roof 806 points to the recent maintenance activity on the whole roof 806 with a single type of roof material. The present application 120 can be utilized to analyze the series of time-lapse images of the roof 806 captured within the above said time period, i.e. from Jan. 9, 2017 to the current date Jan. 4, 2018, and process the images to create the corresponding pixelated images. The artificial intelligence-based image processing instructions of the application 120 analyzes and compares the sequential changes in each of the pixels in the series of time-lapse images of the roof 806 and correlates with the weather information collected over the above period of time to identify the damages caused on the roof 802 during this period. The analysis of the images might have shown the presence of damages throughout the roof 802 caused by a weather activity such as a hailstorm activity with hail stone sizes greater than the threshold value for the roof materials covering the whole roof 802. This might have led to the complete replacement or maintenance of the roofing material, as evident from the image 820. The roof 806 in the image 820 is covered with sheets of material such as, but not limited to, the spray polyurethane foam or TPO sheet products or other product that causes seams at the joints, which are visible on the roof 806 in the image 820.

Thus, the present application 120 analyzes the series of time-lapse images of the roofs and the artificial intelligence-based instructions of the application 120 continuously learns from each cycle of processing the images for providing more accurate results to the al estate holding companies for properly managing the roofs of the buildings associated with the properties managed by them. In some other instances, the artificial intelligence-based instructions of the application 120 preforms automated and continuous analysis of the roofs of the buildings associated with the properties of the real state holding company to identify the serviceable roofs with damages and to provide real-time alerts for contacting the alerting the relevant personnel for performing the necessary maintenance activities on the roofs to maintain the optimal valuation of the properties. The artificial intelligence-based instructions of the application 120 identifies the serviceable roofs by analyzing the sequential changes in the respective pixels of the series of time-lapse images and correlating with the roof characteristics and the weather activities during the series of time-lapse images capable of damaging the particular roof type. This in turn helps the real estate holding companies to claim their roofing insurances from their roofing insurance service provider.

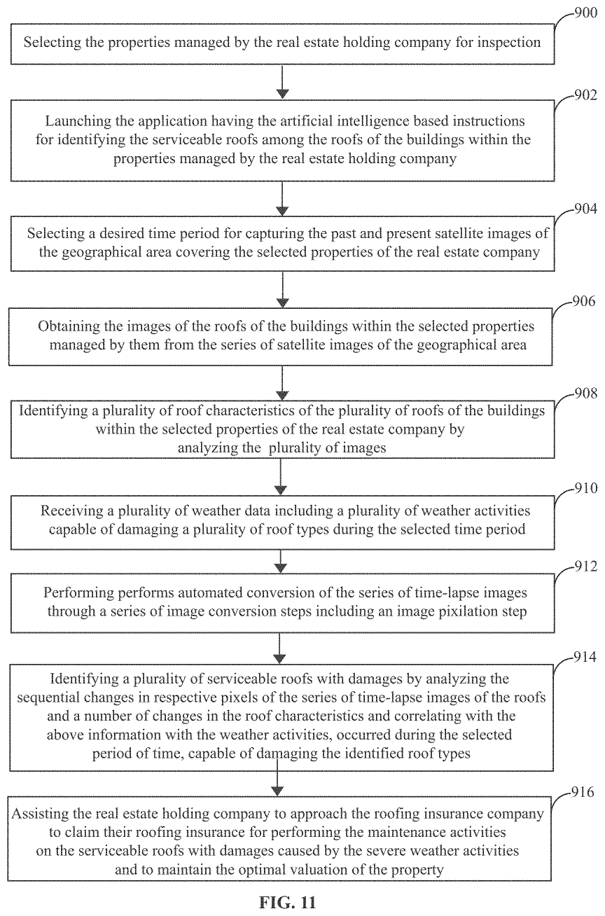

The disclosed principles further includes a computer-implemented method for assisting one or more real estate holding companies to maintain an optimal valuation for one or more properties owned by them, according to an exemplary embodiment of the disclosed principles. FIG. 11 is a flowchart showing the steps of the present method for assisting the real estate holding companies to maintain an optimal valuation for one or more properties owned by them, according to an exemplary embodiment of the disclosed principles. The method includes the steps of selecting the properties managed by the real estate holding company for inspection, as in block 900. The real estate holding companies can now launch the application 120 having the artificial intelligence-based instructions, from an electronic computing device 102, for identifying the serviceable roofs among the roofs of the buildings within the properties managed by the real estate holding company, as in block 902. The real estate holding company operating the application 120 can now obtain the images of the roofs of the buildings within the selected properties managed by them. The images of the roofs of the buildings within the selected properties managed by the real estate holding company is obtained in form of the series of time-lapse images of the properties captured from the past and present satellite images of the geographical area covering the selected properties of the real estate holding company. In some instances, the application 120 allows the users to select a desired time period for capturing the past and present satellite images of the geographical area covering the selected properties of the real estate holding company, as in block 904. The time-lapse images of the roofs of the buildings within the selected properties of the real estate holding companies are obtained from the above satellite images, as in block 906. Now as in block 908, the artificial intelligence-based instructions of the application 120 analyzes the series of time-lapse images of the roofs and identifies the roof characteristics of each of the roofs of the buildings within the selected properties managed by the real estate holding company. The artificial intelligence-based instructions of the application 120, when executed using the processor 106 of the electronic computing device 102, enables identification of the information related to the roofs of the buildings within the properties of the real estate holding company, where the information includes the roof characteristics of each of the roofs including the roof type, an age of the roof, at least one roof material, at least one roof dimension, at least one roof maintenance related information, at least one pre-existing roof damage related information, at least one material covering the roof, and other related roof information and the serviceable roofs among the roofs with one or more damages. The application 120 also receives the weather data including information related to the weather activities capable of damaging the one or more roof types identified from the images of the roofs during the desired time period, as in block 910. Now, the artificial intelligence-based instructions of the application 120 performs automated conversion of the series of time-lapse images through a number of image conversion steps including an image pixilation step, as in block 912. The damages on the roofs is identified by analyzing the sequential changes in respective pixels of the series of time-lapse images and a number of changes in the roof characteristics and correlating with the above information with the weather activities, occurred during the said period of time, capable of damaging each of the roof types of the buildings within the selected properties of the real estate holding company. As in step 914, the automated conversion of the series of time-lapse images through the image conversion steps including the image pixilation step identifies the serviceable roofs with damages among the roofs of the buildings within the selected properties of the real estate holding company. Once the serviceable roofs with damages are identified, the application 120 enables the real estate holding company to approach the roofing insurance company to claim their roofing insurance for performing the maintenance on the serviceable roofs with damages mainly caused by the severe weather activity. In some instances, the application 120 enables an automated and a manual analysis of the images presented in form of the series of time-lapse images of the roofs to identify the roof characteristics.

In some other instances, the present method enables the real estate holding company to predict a variety of roofing maintenance related information, such as but not limited to, at least one type of roof maintenance required, an approximate cost of maintenance, materials required for roof maintenance, a time frame for availing the roofing insurance claims and other relevant maintenance information of the roofs of the buildings within the selected properties under monitoring. This way the present application 120 can be utilized by the real estate holding companies to perform necessary maintenance activities on the roofs of the buildings within the properties managed by them and thus to maintain the optimal valuation for their properties, as in block 916. Further, the electronic computing device 102 running the present application 120 enables the real estate holding companies to estimate a valuation of one or more properties having one or more buildings based on the past and present information related to the roofs including the roof characteristics and the maintenance activities performed on the roofs of the buildings associated with the properties.

Further, it should be noted that the steps described in the method of use could be carried out in many different orders according to user preference. The use of “step of” should not be interpreted as “step for”, in the claims herein and is not intended to invoke the provisions of 35 U.S.C. § 112, (6). Upon reading this specification, it should be appreciated that, under appropriate circumstances, considering such issues as design preference, user preferences, marketing preferences, cost, technological advances, etc., other methods of use arrangements, elimination or addition of certain steps, including or excluding certain maintenance steps, etc., may be sufficient.

The foregoing description of the exemplary embodiments of the disclosed principles have been presented for the purpose of illustration and description. While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

What is claimed is:

1. A method for assisting at least one real estate holding company to maintain an optimal valuation for a plurality of properties having a plurality of buildings comprises the steps of:
a) selecting the plurality of properties being managed by the real estate holding company for inspection;
b) launching an application having a plurality of artificial intelligence-based instructions, from an electronic computing device, for identifying a plurality of serviceable roofs among a plurality roofs of the buildings within the plurality of properties;
c) obtaining a plurality of images of the roofs of the buildings within the properties, wherein the images being a series of time lapse images of the roofs of the buildings obtained from a plurality of past and present satellite images of the properties captured over a selected period of time;
d) analyzing the images of the roofs using the artificial intelligence-based instructions of the application to identify a plurality of information related to each of the roofs, wherein the plurality of information includes a plurality of roof characteristics and a plurality of damage related information of each of the roofs during the selected period of time;
e) identifying the plurality of buildings with the plurality of serviceable roofs requiring maintenance by analyzing a plurality of pixelated images of the roofs obtained from the series of time lapse images of the roofs of the buildings; and
f) contacting at least one insurance service provider providing insurance coverage to the plurality of buildings with the plurality of serviceable roofs requiring maintenance to perform a plurality of maintenance activities.

2. The method of claim 1, wherein the application enables the real estate holding company to maintain the optimal valuation of the buildings associated with the plurality of properties by performing the plurality of maintenance activities on the plurality of serviceable roofs,
wherein the plurality of serviceable roofs suggested by the application includes the plurality of roofs having a plurality of damages caused by a plurality of weather activities capable of damaging the roofs.

3. The method of claim 1, wherein the plurality of plurality of serviceable roofs having the plurality of damages is identified by correlating a plurality of sequential changes identified from the pixelated images of the roofs and a plurality changes in the roof characteristics identified from the series of time-lapse images of the roofs with the weather activities capable of damaging the roofs occurred during the selected period of time.

4. The method of claim 1, wherein the plurality of roof characteristics is identified using the artificial intelligence-based instructions of the application by comparing a plurality of features identified from the series of time-lapse images of the roofs to a plurality of predefined roof features associated with a plurality of roof types stored in a dynamically updated database associated with the application,
wherein the plurality of roof characteristics includes a roof type, an age of the roof, at least one roof material, at least one roof dimension, at least one roof maintenance related information, at least one pre-existing roof damage related information, at least one material covering the roof, and other related roof information.

5. The method of claim 1, wherein the artificial intelligence-based instructions of the application performs analysis of the series of time-lapse images of the roofs, captured prior to and after the occurrence of the plurality of weather activities capable of damaging the roofs, to identify the plurality of damages on the roofs caused by the weather activities,
wherein the weather activities include a plurality of hailstorm activities with hail stones of sizes capable of damaging the roofs, heavy rain, wind, storm, lightning and other weather related activities capable of damaging the roofs.

6. The method of claim 1, wherein the application enables automated inspection and identification of the plurality of serviceable roofs among the plurality of roofs of the buildings associated with the plurality of properties managed by the real estate holding company from a centralized location,
wherein centralized monitoring of the plurality of properties from the centralized location utilizing the application running on the electronic computing device enables reduction in overall costs associated with the management of the plurality of properties.

7. The method of claim 1, wherein the application enables the real estate holding companies to schedule and perform a plurality of planned maintenance activities on the plurality of serviceable roofs of the buildings associated with the plurality of properties.

8. The method of claim 1, wherein the images are generated using multispectral imaging technology selected from the group consisting of infrared, ultra-violet and thermal imaging.

9. A computer implemented system for assisting a plurality of real estate holding companies to maintain an optimal valuation for a plurality of properties having a plurality of buildings, the system comprising an electronic computing device comprising:
a) a memory unit to store a plurality of instructions of an application for identifying a plurality of serviceable roofs among a plurality roofs of the buildings within the plurality of properties managed by the plurality of real estate holding companies; and
b) a processor configured to execute the plurality of instructions of the application to perform a plurality of tasks including:
1) obtaining a plurality of images of the roofs of the buildings within the plurality of properties, wherein the images of the roofs being a series of time-lapse images of the roofs, obtained from a plurality of past and present satellite images of the properties, captured over a selected period of time;
2) obtaining a plurality of weather data of a geographical area covering the plurality of properties, during the selected period of time, from at least one weather data service provider;
3) processing the plurality of images of the roof using a plurality of artificial intelligence-based instructions of the application to identify the plurality of information related to each of the roofs including a plurality of roof characteristics and a plurality of damage related information; and
4) identifying the plurality of serviceable roofs among the plurality roofs of the buildings within the plurality of properties managed by the plurality of real estate holding companies.

10. The computer implemented system of claim 9, wherein the electronic computing device running the application identifies the plurality of serviceable roofs with a plurality of damages caused by a plurality of factors including a plurality of weather activities capable of damaging the roofs,
wherein the application identifies the plurality of damages by analyzing a plurality of sequential changes in a plurality of pixels in the series of time-lapse images and a plurality of changes in the roof characteristics and correlating with the plurality of weather activities occurred during the selected period of time capable of damaging the roofs.

11. The computer implemented system of claim 9, wherein the electronic computing device running the application enables the real estate holding companies to request for at least one insurance claim from an insurance service provider for performing a plurality of maintenance activities on the plurality of serviceable roofs of the plurality of buildings within the plurality of properties managed by the real estate holding companies,
wherein the plurality of maintenance activities on the plurality of serviceable roofs of the plurality of buildings within the plurality of properties enables the real estate holding companies maintain the optimal valuation of the properties.

12. The computer implemented system of claim 9, wherein the electronic computing device running the application enables the real estate holding companies to estimate a valuation of the plurality of properties based on a plurality of past and present information related to the roofs including the roof characteristics and the maintenance activities on the roofs of the plurality of buildings associated with the properties.

13. The computer implemented system claim 9, wherein the images are generated using multispectral imaging technology selected from the group consisting of infrared, ultra-violet and thermal imaging.
